(19) United States
(12) Patent Application Publication
(10) Pub. No.: US 2016/0091109 A1
(43) Pub. Date: Mar. 31, 2016

(54) LOW TORQUE MULTI-CIRCUIT CONTROL VALVE

(71) Applicant: Parker-Hannifin Corporation, Cleveland, OH (US)

(72) Inventors: Andrew Thomas Woods, Kalamazoo, MI (US); Andrew Gregory Bornhorst, Richland, MI (US); David William Van Eerden, Middleville, MI (US); Keith Ray Harger, Kalamazoo, MI (US); Steven James Dohm, Ravenna, MI (US)

(21) Appl. No.: 14/828,786

(22) Filed: Aug. 18, 2015

Related U.S. Application Data
(60) Provisional application No. 62/057,393, filed on Sep. 30, 2014.

(51) Int. Cl. F16K 31/524

(52) U.S. Cl. CPC F16K 31/52408

(57) ABSTRACT

A control valve includes a valve housing, a plurality of valves located within the valve housing, and a moveable member that is configured to move within the housing, the moveable member including a plurality of cam extensions. As the moveable member moves (e.g., rotates), the cam extensions interact against the valves to open and close the valves in a prescribed order. The control valve may be controlled to inflate a zoned object. The valves may include at least two zone valves for communicating pressurized air into the object, and a vent valve for venting the object via the zone valves. At any given position of the moveable member, the cam extensions are positioned to one of: opening one of the zone valves, opening one of the zone valves and the vent valve, or maintaining all of the valves closed. The rotating member may be a cylindrical cam shaft with radially extending cams.

### RELATED APPLICATION DATA

This application claims priority to U.S. provisional application No. 62/057,393, filed on Sep. 30, 2014 and incorporated here by reference.

### FIELD OF INVENTION

The present invention relates to multi-circuit control valves that are utilized for controlling pressure in multiple pressure zones of a zoned inflatable object.

### BACKGROUND OF THE INVENTION

Control valves commonly are employed to control pressure and flow of a fluid, such as pressurized air. Control valves may be configured to act as a multi-way valve that controls pressure and flow through various permutations of multiple zone configurations.

For example, certain objects need to be inflated or otherwise subjected to pressurized air (or other gases). To enhance the inflation or other pressurization process, the object may be divided into multiple pressure zones that are individually pressure controlled and inflated. An example of such a zoned inflatable device is an air mattress. It is desirable that an air mattress be pressurized in a manner to enhance comfort. This may be accomplished by dividing the mattress into different zones of pressure to provide for a more targeted and adjustable inflation. For support, a user may desire, for example, certain zones to be pressurized at higher pressures as compared to other zones. The efficacy of the pressurization is thus enhanced by dividing the air mattress internally into multiple pressure zones in which the pressure is individually controlled. By using multiple pressure zones, enhanced precision of control is achieved over the entire air mattress as compared to controlling the pressure within the entire mattress as a unit. The result is a more flexible or adjustable inflation, which enhances the comfort of the air mattress.

Conventional uses of multiple pressure zones, however, have certain drawbacks. In conventional systems, each zone may be provided with its own individual control mechanism, such as a control valve. Accordingly, the number of valves and related components increases with the number of zones utilized. Separate control of each zone further adds to the complexity of the system. Accordingly, although the use of multiple zones provides for more precise control of pressure, the control mechanism is more complex as compared to single zone control. A simple mechanism for efficient control of multiple pressure zones in a zoned inflatable device has been difficult to achieve.

### SUMMARY OF THE INVENTION

A need in the art exists for an improved control mechanism for controlling pressure or inflation of a zoned inflatable object containing multiple pressure zones. The present invention provides an enhanced control mechanism for multiple pressure zones each pressured via an individual air circuit, the control mechanism being configured as a single, low torque multi-circuit control valve.

An aspect of the invention is a control valve. In exemplary embodiments, the control valve includes a valve housing, a plurality of valves located within the valve housing, and a moveable member that is configured to move within the housing, the moveable member including a plurality of cam extensions. As the moveable member moves (e.g., rotates), the cam extensions interact against the valves to open and close the plurality of valves in a prescribed order. The control valve may be controlled to inflate a zoned object having multiple zones for receiving a pressurized fluid, such as pressurized air. The plurality of valves may include at least two zone valves for communicating pressurized air into the zoned inflatable object. The plurality of valves further may include a vent valve for venting the zoned object via the zone valves. At any given position of the moveable member, the cam extensions are positioned to one of: opening one of the zone valves, opening one of the zone valves and the vent valve, or maintaining all of the valves closed.

The moveable member may be a cylindrical rotating cam shaft with radially extending cam extensions. The cam extensions may include at least a first cam for interacting against the zone valves and a vent cam for interacting against the vent valve as the rotating member rotates. The first cam may have an arc expanse for maintaining one of the zone valves in an open position as the rotating member rotates over the arc expanse. The arc expanse of the first cam may be 30°. In an alternative embodiment, the rotating member may be a rotating cam disc, and the cam extensions extend outward from the cam disc. In yet another embodiment, a longitudinally moving shaft is configured with longitudinal cams radially displaced around the shaft.

Another aspect of the invention is a control system for inflating a multiple zoned object. In exemplary embodiments, the control system includes a zoned object having multiple zones to be inflated with a pressurized fluid; a control valve in accordance with the various embodiments of the invention in fluid communication with the zoned object; a motor configured to drive the moveable member of the control valve; a pump for pumping the pressurized fluid for inflating the zoned object; a pressure sensor for sensing the pressure in each of the multiple zones of the zoned object; and an electronic controller. The electronic controller is configured to receive pressure information from the pressure sensor, and to control the pump and motor based on the pressure information. The electronic controller controls the motor to drive the moveable member to a position from among a plurality of positions based on the sensor information to maintain proper inflation of the zoned object. The zoned object, for example, may be an inflatable air mattress.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto. Features that are described and/or illustrated with respect to one embodiment may be used in the same way or in a similar way in one or more other embodiments and/or in combination with or instead of the features of the other embodiments.

### BRIEF DESCRIPTION OF THE DRAWINGS

FIG. 1 is a drawing depicting an isometric view of an exemplary control valve in accordance with embodiments of the present invention.

FIG. 2 is a drawing depicting a side cross-sectional view of the exemplary control valve of FIG. 1, with the cam shaft angle at 0°.

FIG. 3 is a drawing depicting a side cross-sectional view of the exemplary control valve of FIG. 1, with the cam shaft angle at 30°.

FIG. 4 is a drawing depicting a longitudinal cross-sectional view of the exemplary control valve positioned as in FIG. 3, at the line 4-4.

FIG. 5 is a drawing depicting a longitudinal cross-sectional view of the exemplary control valve positioned as in FIG. 3, at the line 5-5.

FIG. 6 is a drawing depicting a longitudinal cross-sectional view of the exemplary control valve positioned as in FIG. 3, at the line 6-6.

FIG. 7 is a chart depicting cam shaft angle positions as related to control valve function for the control valve of FIG. 1.

FIG. 8 is a drawing depicting a side cross-sectional view of the exemplary control valve of FIG. 1, with the cam shaft angle at 60°.

FIG. 9 is a drawing depicting a side cross-sectional view of the exemplary control valve of FIG. 1, with the cam shaft angle at 90°.

FIG. 10 is a drawing depicting a side cross-sectional view of the exemplary control valve of FIG. 1, with the cam shaft angle at 120°.

FIG. 11 is a drawing depicting a side cross-sectional view of the exemplary control valve of FIG. 1, with the cam shaft angle at 150°.

FIG. 12 is a drawing depicting a side cross-sectional view of the exemplary control valve of FIG. 1, with the cam shaft angle at 180°.

FIG. 13 is a drawing depicting a side cross-sectional view of the exemplary control valve of FIG. 1, with the cam shaft angle at 210°.

FIG. 14 is a drawing depicting a side cross-sectional view of the exemplary control valve of FIG. 1, with the cam shaft angle at 240°.

FIG. 15 is a drawing depicting a side cross-sectional view of the exemplary control valve of FIG. 1, with the cam shaft angle at 270°.

FIG. 16 is a drawing depicting an isometric view of a second exemplary control valve in accordance with embodiments of the present invention.

FIG. 17 is a drawing depicting a side cross-sectional view of the second exemplary control valve of FIG. 16.

FIG. 18 is a drawing depicting a bottom view of the second exemplary control valve of FIG. 16.

FIG. 19 is a chart depicting rotational positions as related to control valve function for the control valve of FIG. 16.

FIG. 20 is a drawing depicting a block diagram of operative portions of an exemplary control system for controlling pressure and/or flow in a zoned object.

### DETAILED DESCRIPTION

Embodiments of the present invention will now be described with reference to the drawings, wherein like reference numerals are used to refer to like elements throughout. It will be understood that the figures are not necessarily to scale.

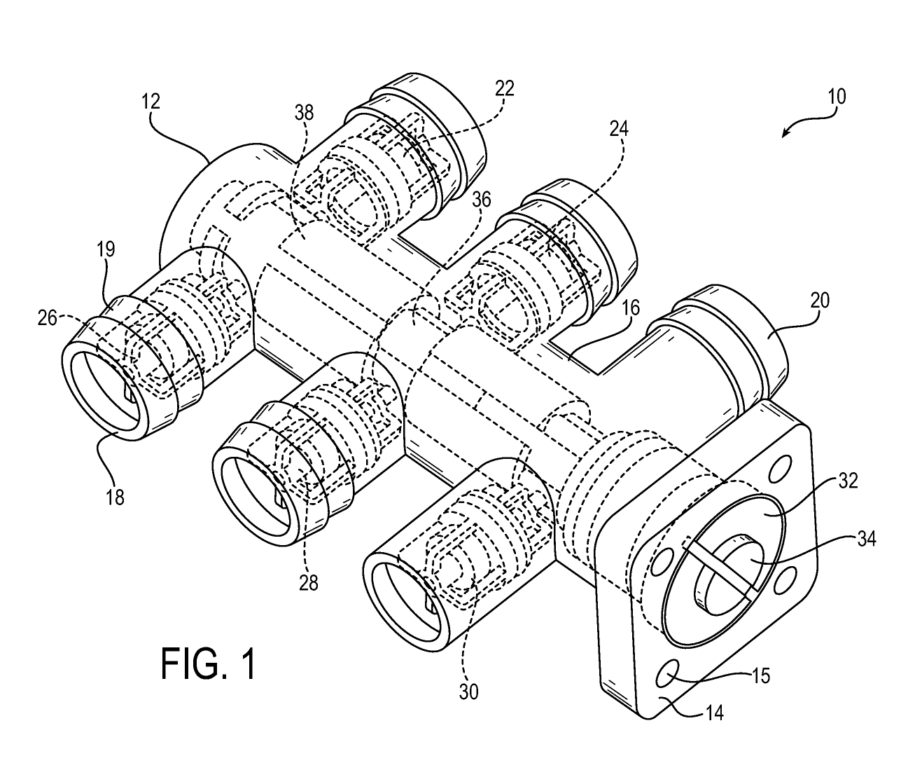

FIG. 1 is a drawing depicting an isometric view of an exemplary control valve 10 in accordance with embodiments of the present invention. The control valve 10 includes a body 12 that acts a comprehensive valve housing. The body/housing 12 includes a mounting plate 14, a centralized cam housing 16, a plurality of individual valve housings 18, and an inlet 20. The mounting plate 14 provides a surface for mounting the control valve to a motor, the operation of which is further explained below. The mounting plate 14 may include a plurality of receiving holes 15, which may receive any suitable fastening element for fixing the control valve to a motor. The cam housing 16 extends from the mounting plate 14 and constitutes a substantially cylindrical housing for receiving a moveable member 32. In this embodiment, the moveable member is configured as a cylindrical rotating cam shaft 32 as described in more detail below.

The individual valve housings 18 each extends laterally from the cam housing 16, as does the inlet 20. The inlet 20 constitutes an inlet for communicating a pressurized fluid from a pump (not shown) into the control valve 10. For example purposes, the pressurized fluid will be designated to be pressurized air, as may be used for inflating an air mattress. It will be appreciated that other pressurized fluids, such as other gases or liquids, may be employed with the current invention, and such use may be with any suitable zoned inflatable object, or other object in which it is desirable for to direct fluid flow in a process that requires different zones depending on downstream conditions.

In exemplary embodiments, the control valve includes at least two zone valves, although any suitable valve number may be employed. In another exemplary embodiment, one of the zone valves may be a vent valve. In this example of FIG. 1, there are five individual valves housings 18 that each receives a corresponding one of a plurality of valves that is located within a respective individual valve housing. Four of the valves provide flow paths or a flow “circuit” for the pressurized air to be delivered into a pressure zone of a multiple zoned inflatable object. Accordingly, the control valve 10 is referred to as a multi-circuit control valve as multiple fluid flow circuits are combined into the single control valve 10. A fifth valve is a vent valve that is in fluid communication with the zone valves when the vent valve is in the open position. As described further below, the rotating member is configured to rotate within the cam housing, and the rotating member includes a plurality of cam extensions. As the rotating member rotates within the cam housing, the cam extensions interact against the plurality of valves, including the zone valve and vent valves, to open and close the plurality of valves in a prescribed order.

As referenced above, an example of such a multiple zoned inflatable object may be an air mattress, although any multiple zoned object for controlled fluid flow may be used with the control valve 10. The example control valve 10 of FIG. 1 includes four zone valves: Zone 1 valve 22, Zone 2 valve 24, Zone 3 valve 26, and Zone 4 valve 28. The valves may be paired such that two valves of the pair are positioned on opposite sides of the cylindrical cam housing 16. In this example configuration, the Zone 1 valve 22 is opposite the Zone 3 valve 26, and the Zone 2 valve 24 is opposite the Zone 4 valve 28, relative to the central cam housing 16. The valve housings 18 for the zone valves, and the inlet 20, may include ridges 19 for coupling to appropriate hose elements for communicating the pressurized air into the zoned inflatable object. The control valve 10 further includes a fifth Vent valve 30 that provides a vent to atmosphere, which is positioned opposite to the inlet 20 relative to the central cam housing 16. It will be appreciated that the number of zone and/or vent valves may be varied. The example of FIG. 1 includes a total of six ports (inlet, vent, and four zones), and more or less ports may be provided. To accommodate a larger number of ports, the cam housing 16 and the received cam shaft 32 may be increased as warranted.

As referenced above, the cam housing 16 receives the moveable member 32. In this exemplary embodiment the moveable member is configured as a cylindrical rotating cam shaft 32, which extends through the cam housing 16. The cam shaft 32 has a first end 34 that interfaces with the motor (not shown). The cam shaft 32 further includes a plurality of valve interacting portions 36 that may interact with corresponding zone and vent valves, and body portions 38 located between the valve interacting portions 36. The valve interacting portions 36 of the cylindrical cam shaft include a plurality of cam extensions that extend radially from the cam shaft.

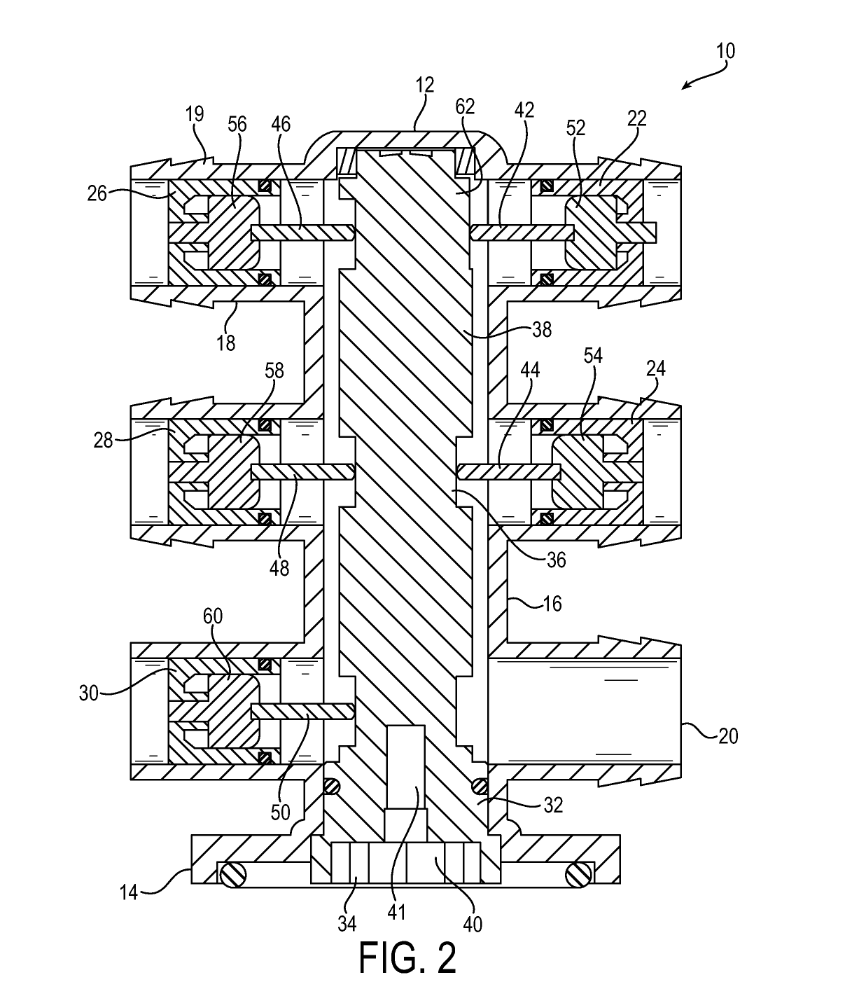

FIGS. 2-6 and 8-15 are drawings depicting various views of the control valve 10 of FIG. 1, or portions thereof. Accordingly, like components are designated with the same reference numerals in FIGS. 2-6 and 8-15 as in FIG. 1. In general operation, a motor drives the cam shaft to rotate the cam shaft within the housing of the control valve. Based on the rotational position of the cam shaft, the cam extensions that extend from the cam shaft open and close the zone and vent valves in a prescribed order to control pressure in multiple zones of a zoned inflatable associated with and in fluid communication with the zone valves. At each particular rotational position of cam shaft, the cams that extend from the cam shaft may interact to open one or more of the zone valves and vent valve, or all of the valves may be closed. In exemplary embodiments, at any given rotational position of the rotating member (cam shaft), the cam extensions are positioned to one of: opening one of the zone valves, opening one of the zone valves and the vent valve, or maintaining all of the plurality of valves closed. The functional operation of the control valve relative to the rotational position of the cam shaft is described in detail with reference to the additional figures.

FIG. 2 is a drawing depicting a side cross-sectional view of the exemplary control valve 10 of FIG. 1. As seen in FIG. 2, the first end 34 of the cam shaft 32 includes a drive link 40 coupled to a drive shaft 41. The motor ultimately drives the drive shaft 41 to rotate the drive shaft, which in turn drives rotation of the entire cam shaft 32. Each of the zone valves and vent valve may be configured comparably, with each having a valve stem that extends from a valve body. For example, the four Zone valves 22, 24, 26, and 28, and Vent valve 30, respectively may include valve stems 42, 44, 46, 48, and 50, and respectively may include valve bodies 52, 54, 56, 58, and 60.

By definition, the depiction of FIG. 2 is designated as the cam shaft 32 being at a rotational angle or position of 0°. As seen in FIG. 2, the cam shaft 32 has a first cam 62 that extends radially from the cylindrical cam shaft. At the rotational angle defined as 0°, the first cam 62 extends against the valve stem 42 of the Zone 1 valve 22. In this manner, the first cam 62 pushes outward the valve stem 42, thereby opening the Zone 1 valve 22. In other words, at the cam shaft angle of 0°, the Zone 1 valve 22 is open. It is further seen in FIG. 2 that no other cams are interacting with any other of the Zone valves or the Vent valve. Accordingly, at the cam shaft rotational angle or position defined as 0°, all valves other than the Zone 1 valve are closed. The 0° rotational position, therefore, is used to inflate Zone 1 of the zoned inflatable object, as the Zone 1 valve is open to permit the passage of pressurized air received via the inlet 20.

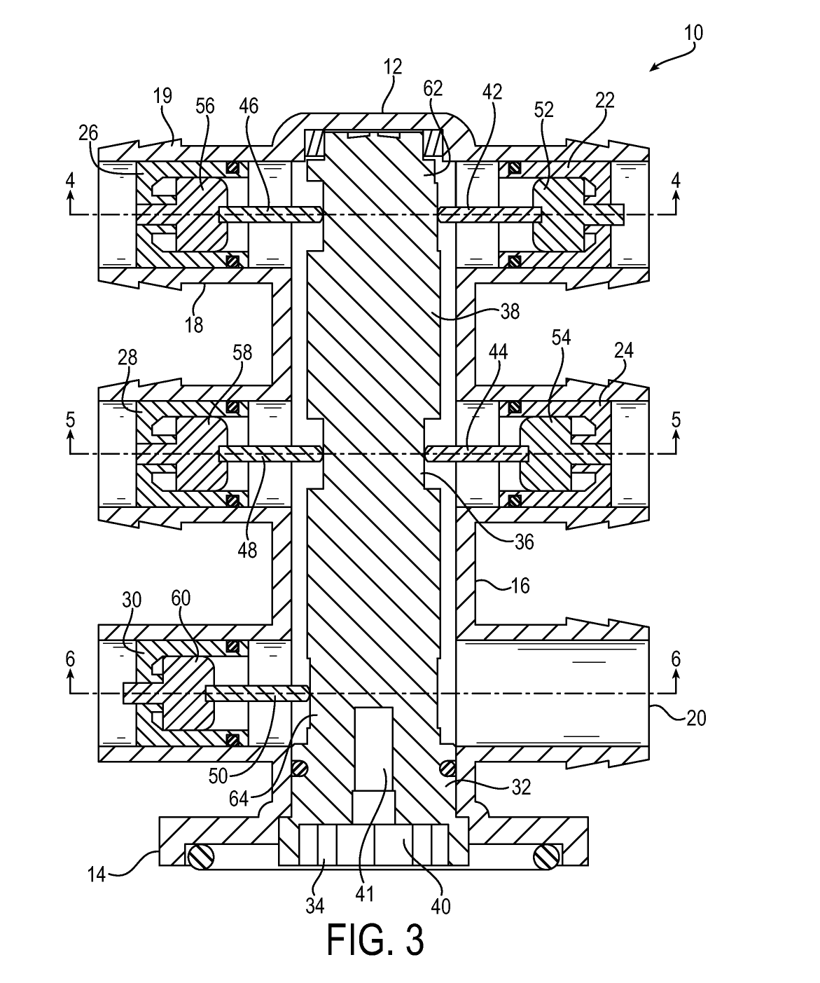

FIG. 3 is a drawing depicting a side cross-sectional view of the exemplary control valve 10 of FIG. 1, with the cam shaft angle at 30°. In other words, the cam shaft has been rotated by 30° relative to the rotational position in FIG. 2. In FIG. 3, it is seen that the first cam 62 remains interacting against the valve stem 42 of the Zone 1 valve 22. In other words, at the cam shaft angle of 30°, the Zone 1 valve 22 remains open. In addition, at the rotational angle of 30°, a vent cam 64 extends against the valve stem 50 of the Vent valve 30. In this manner, the vent cam 64 pushes outward the valve stem 50, thereby opening the Vent valve 30. In other words, at the cam shaft angle of 30°, both the Zone 1 valve 22 and the Vent valve 30 are open. It is further seen in FIG. 3, that no other cams are interacting with any other of the Zone valves for Zones 2, 3, and 4. The 30° rotational position, therefore, is used to vent Zone 1 to regulate the Zone 1 pressure. To vent Zone 1, air is stopped from flowing into the control valve from the inlet 20. In addition, with both the Zone 1 and Vent valves open, air can flow through the Zone 1 valve 22 and be vented out through the Vent valve 30.

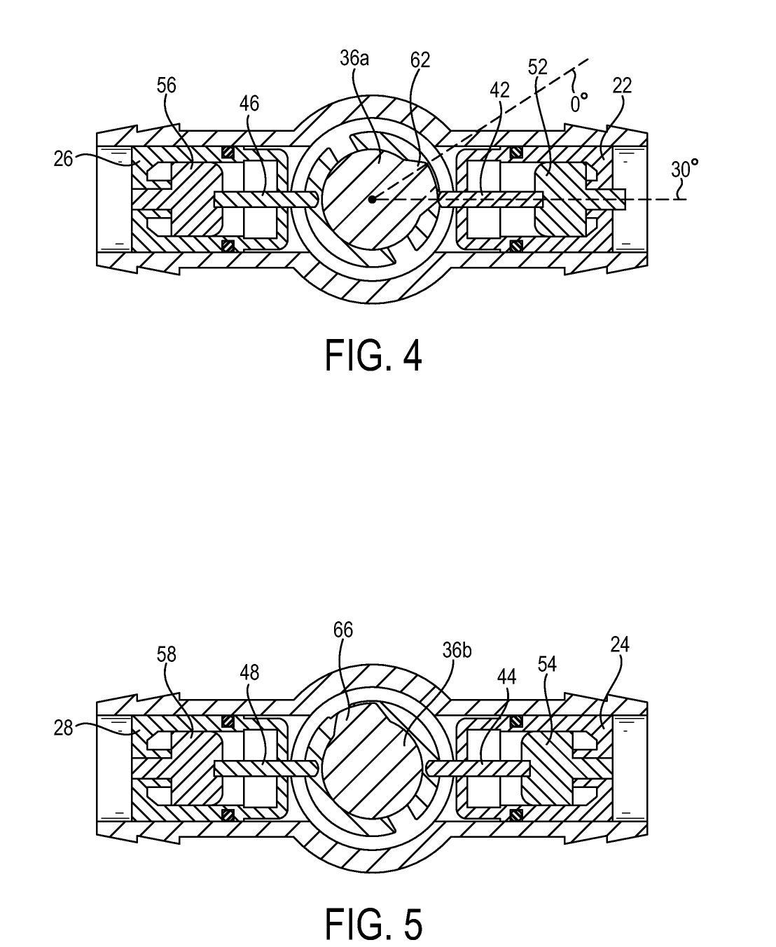

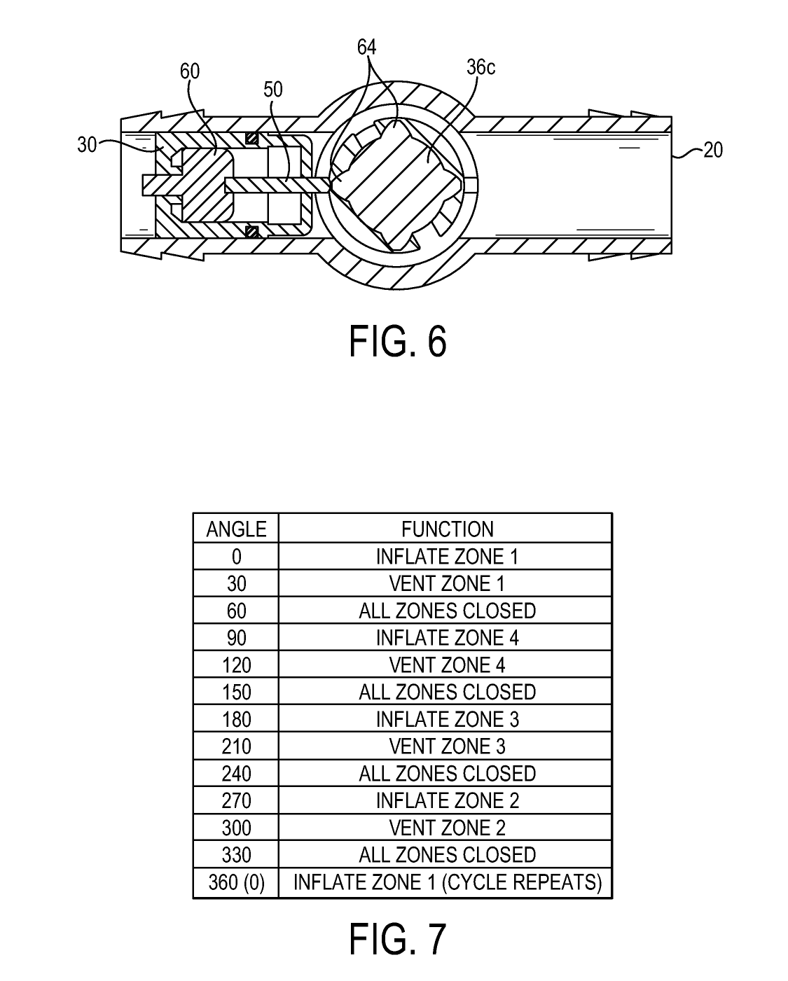

FIGS. 4-6 illustrate additional details in the manner of operation of the control valve 10, using the 30° rotational position of FIG. 3 for illustration purposes. In particular, FIG. 4 is a drawing depicting a longitudinal cross-sectional view of the exemplary control valve 10 positioned as in FIG. 3, at the line 4-4. FIG. 5 is a drawing depicting a longitudinal cross-sectional view of the exemplary control valve 10 positioned as in FIG. 3, at the line 5-5. FIG. 6 is a drawing depicting a longitudinal cross-sectional view of the exemplary control valve 10 positioned as in FIG. 3, at the line 6-6.

FIG. 4, therefore, depicts a cross-sectional view at the cam shaft location associated with Zone 1 and Zone 3. Above, reference numeral 36 designated generally the valve interacting portions 36 of the cam shaft 32. Accordingly, in FIG. 4 the valve interacting portion is more specifically designated as a first valve interacting portion 36a. First valve interacting portion 36a includes the first cam 62 referenced above. A 0° degree line also is indicated in FIG. 4, which represents the position of the cam shaft associated with FIG. 2. As seen FIG. 4, the first cam 62 essentially spans a 30° arc expanse. Therefore, as described above, the first cam 62 opens the Zone 1 valve 22 beginning at the 0° rotation position. As the cam shaft rotates counterclockwise from the 0° position to the 30° position of FIG. 4, the first cam 62 maintains contact against the valve stem 42 over the entirety of the 30° arc expanse of the first cam. In this manner, as referenced above the Zone 1 valve 22 is maintained in the open position at both rotational cam positions of 0° and 30° as the rotating member rotates over the arc expanse of the first cam.

It will be appreciated that further counterclockwise rotation of the cam shaft from FIG. 4 will result in the first cam 62 releasing from the valve stem 42. The Zone 1 valve will close upon such release. With further rotation of the cam shaft, the first cam 62 will come into interact against the valve stem 46 of the Zone 3 valve 26. Upon such contact, the Zone 3 valve 26 will open, and will remain open through an additional 30° rotation from first contact, similarly as the Zone 1 valve from 0°-30°.

FIG. 5 depicts a cross-sectional view at the cam shaft location associated with Zone 2 and Zone 4 at the 30° rotational position of FIG. 3. As seen in FIG. 5, a second valve interacting portion 36b includes a second cam 66 that extends from the cam shaft 32. The second cam 66 is configured at times to interact with and press against either of the second valve stem 44 of the Zone 2 valve 24, or the fourth valve stem 48 of the Zone 4 valve 28. At the depicted 30° rotational position, however, the second cam 66 is not in contact with either of the valve stems of the Zone 2 or Zone 4 valves. Therefore, as referenced above, both the Zone 2 and Zone 4 valves are closed at the rotational cam position of 30°. It will be appreciated that further counterclockwise rotation of the cam shaft from FIG. 5 will result in the second cam 66 coming to interact against the valve stem 48 of the Zone 4 valve 28. Upon such contact, the Zone 4 valve 28 will open, and will remain open through an additional 30° rotation from first contact, as the second cam 66 also spans an arc of 30° similarly as the first cam 62. Even further counterclockwise rotation of the cam shaft will result in the second cam 66 coming to interact against the valve stem 44 of the Zone 2 valve 24. Upon such contact, the Zone 2 valve 24 will open, and will remain open through an additional 30° rotation from first contact.

FIG. 6 depicts a cross-sectional view at the cam shaft location associated with the Vent valve 30 at the 30° rotational position of FIG. 3. As seen in FIG. 6, a third valve interacting portion 36c includes a plurality of vent cams 64 (identified above) that extend from the cam shaft 32. The vent cams 64 are configured at times to interact with and press against the valve stem 50 of the vent valve 30 to open the Vent valve. At the depicted 30° rotational position, one of the vent cams 64 is interacting against the valve stem 50 of the Vent valve 30. Therefore, as referenced above, the Vent valve is open at the rotational cam position of 30° to vent Zone 1, as the Zone 1 valve also is open. In contrast to the first and second cams 62 and 66, the vent cams 64 do not have any significant rotational arc expanse. It will be appreciated, therefore, that further counterclockwise rotation of the cam shaft from FIG. 6 will result in the vent cam 64 releasing from the valve stem 50. The Vent valve will close upon such release. With further rotation of the cam shaft, another one of the vent cams 64 will come to interact against the valve stem 50 of the Vent valve 30. Upon such contact, the Vent valve 30 will open again to vent one of the Zones depending upon which one of the Zone valves is open. Accordingly, in this example embodiment there are four vent valves 64 to permit venting of each of the four zones.

In this manner, based on the rotational position of the cam shaft 32, cams 62, 64, and 66 that extend from the cam shaft open and close the zone and vent valves in a prescribed order to control pressure in multiple zones of a zoned inflatable object associated with and in fluid communication with each of the zone valves. At each particular rotational position of cam shaft, the cams may interact to open one or more of the zone valves and vent valve, or all the valves may be closed. FIG. 7 is a chart depicting cam shaft angle or rotational positions as related to control valve function for the control valve of FIG. 1. The chart shows the angle rotational position of the cam shaft and the functional result as the cam shaft 32 is rotated counterclockwise from the 0° position. The 0° and 30° positions already are described above. References to inflating a zone means that a cam of the cam shaft is interacting against the valve stem for the corresponding Zone valve. For example, at the 180° rotational position, “Inflate Zone 3” means the first cam 62 is interacting against the third valve stem 46 to open the Zone 3 valve 26. At the 210° position, “Vent Zone 3” means that the first cam 62 retains the Zone 3 valve 26 as open (due to the 30° arc of the first cam 62), and one of the vent valves 64 now interacts against the valve stem 50 to open the Vent valve 30, thereby venting Zone 3.

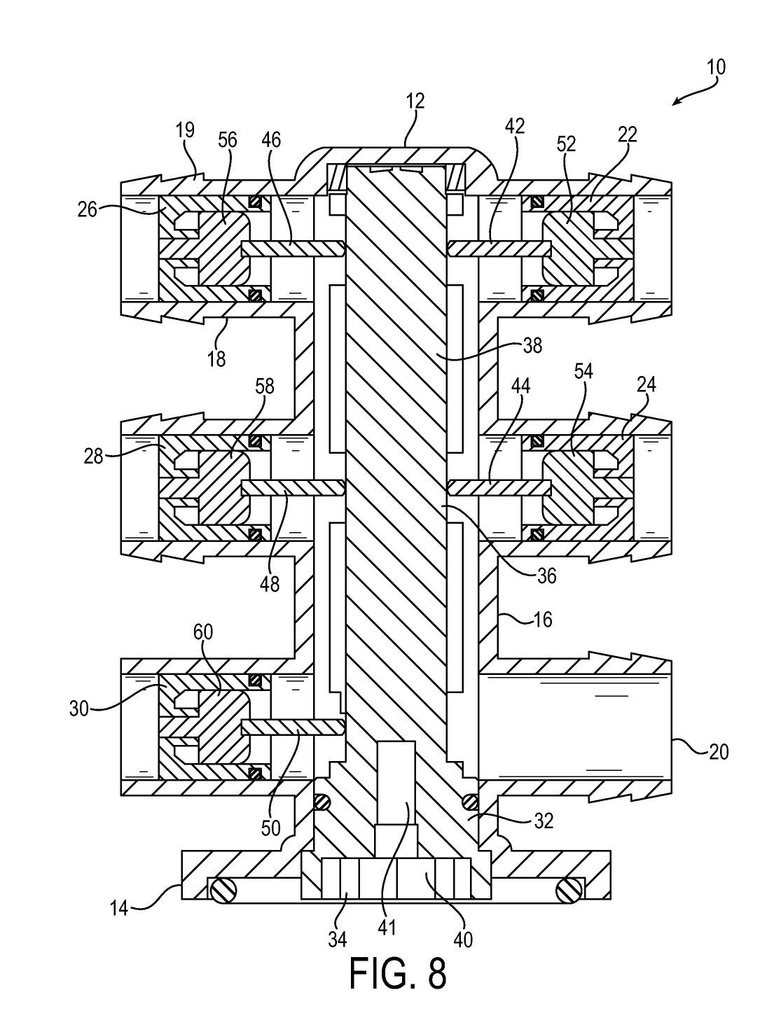

FIGS. 8-15 depict the control valve 10 at additional angle or rotational positions in correspondence with the chart of FIG. 7. FIG. 8 is a drawing depicting a side cross-sectional view of the exemplary control valve 10, with the cam shaft angle at the 60° position. Referring to the chart of FIG. 7, all zones (including the vent) are closed. As seen in FIG. 8, at such positioning none of the cams of the cam shaft are interacting against the zone or vent valves.

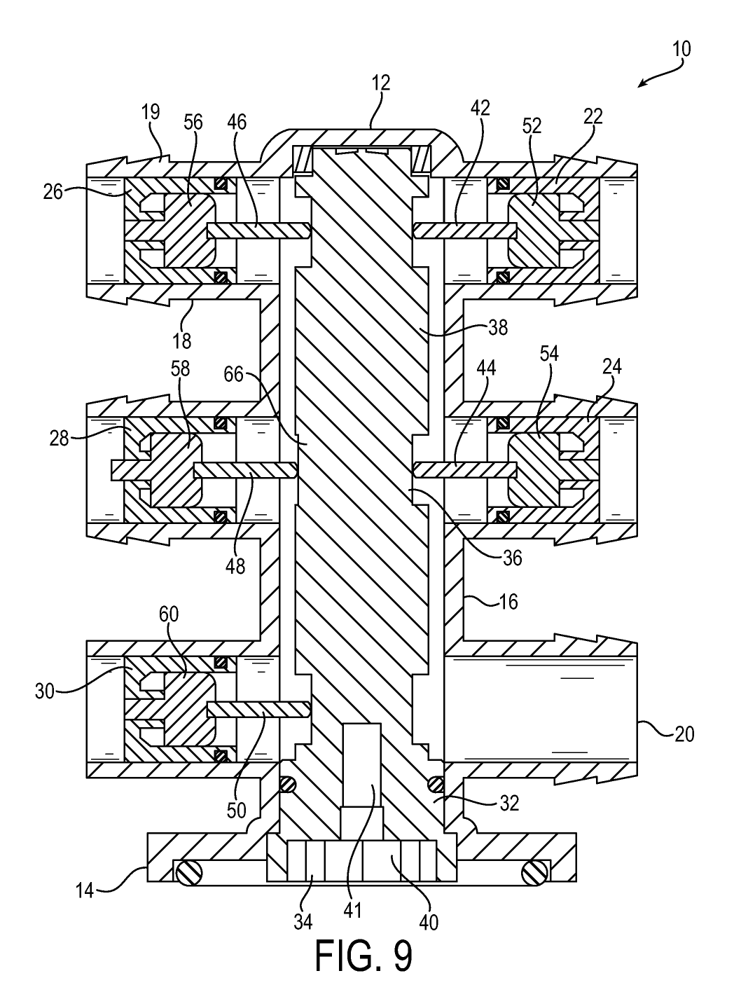

FIG. 9 is a drawing depicting a side cross-sectional view of the exemplary control valve 10, with the cam shaft angle at the 90° position. Referring to the chart of FIG. 7, Zone 4 is being inflated. As seen in FIG. 9, the second cam 66 is interacting against the fourth valve stem 48 to open the Zone 4 valve 28. All other zones (including the vent) are closed.

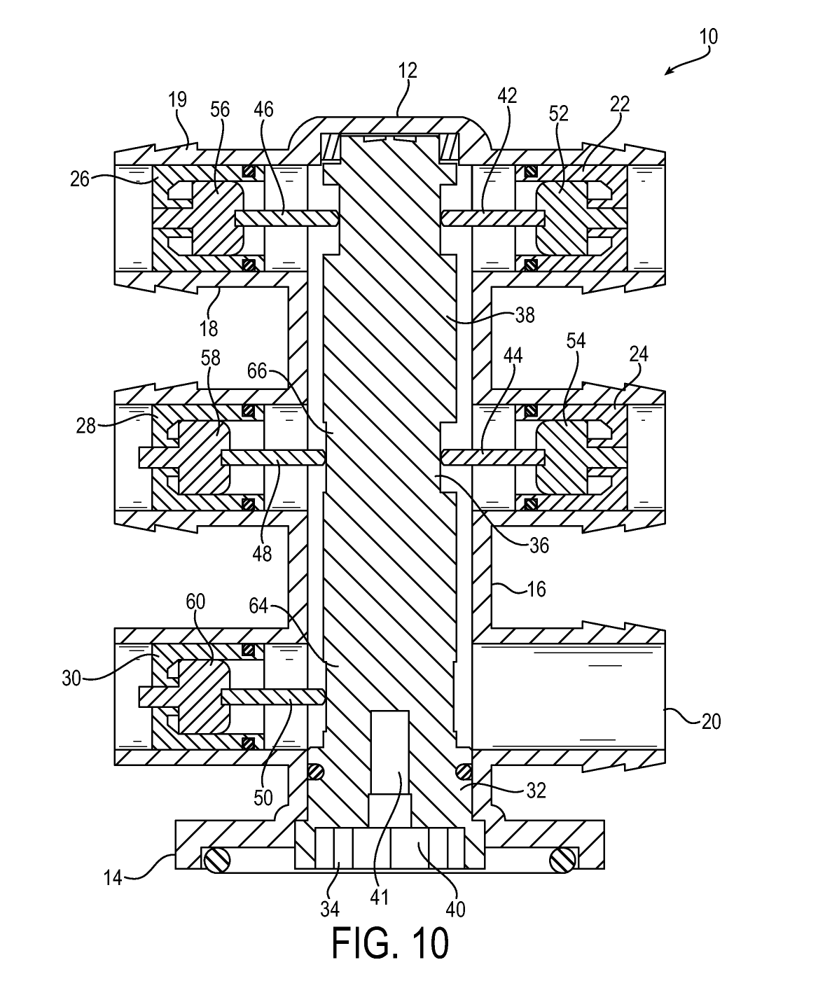

FIG. 10 is a drawing depicting a side cross-sectional view of the exemplary control valve 10, with the cam shaft angle at the 120° position. Referring to the chart of FIG. 7, Zone 4 is being vented. As seen in FIG. 10, the second cam 66 remains interacting against the fourth valve stem 48 to open the Zone 4 valve 28, and a vent cam 64 is interacting with the valve stem 50 of the vent valve 30 to open the vent valve. The vent is therefore in fluid communication with Zone 4 valve to permit venting of Zone 4. All other zones are closed.

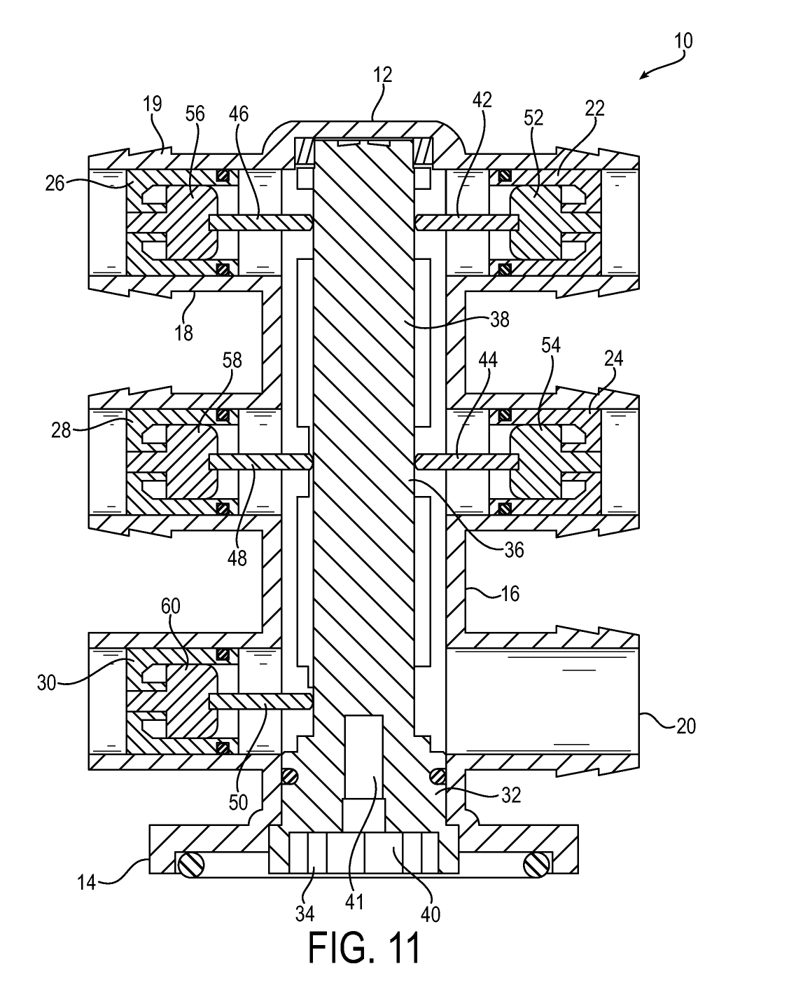

FIG. 11 is a drawing depicting a side cross-sectional view of the exemplary control valve 10, with the cam shaft angle at the 150° position. Referring to the chart of FIG. 7, all zones (including the vent) are closed. As seen in FIG. 11, at such positioning none of the cams of the cam shaft are interacting against the zone or vent valves.

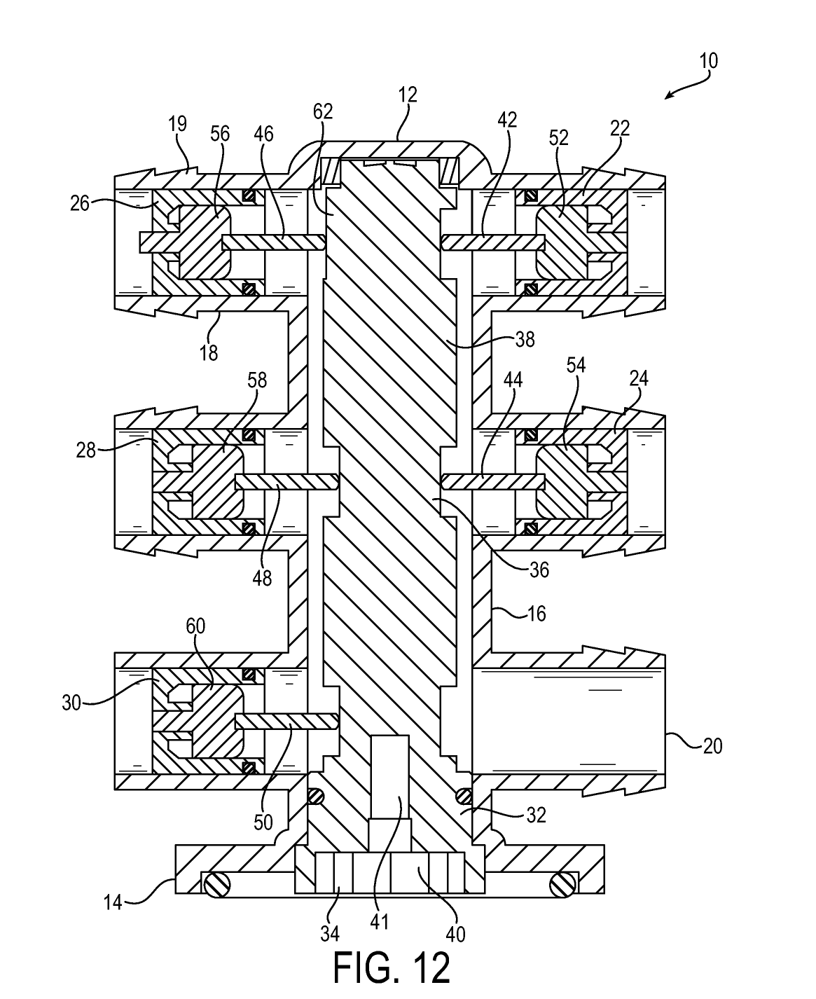

FIG. 12 is a drawing depicting a side cross-sectional view of the exemplary control valve 10, with the cam shaft angle at the 180° position. Referring to the chart of FIG. 7, Zone 3 is being inflated. As seen in FIG. 12, the first cam 62 is interacting against the third valve stem 46 to open the Zone 3 valve 26. All other zones (including the vent) are closed.

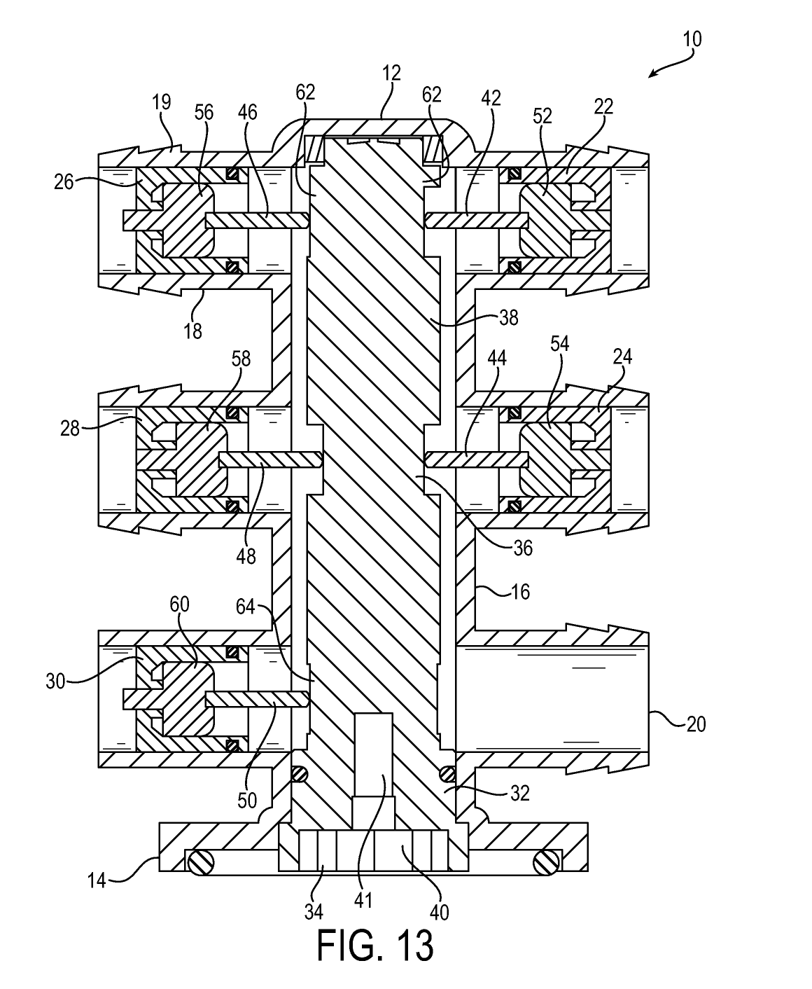

FIG. 13 is a drawing depicting a side cross-sectional view of the exemplary control valve 10, with the cam shaft angle at the 210° position. Referring to the chart of FIG. 7, Zone 3 is being vented. As seen in FIG. 13, the first cam 62 remains interacting against the third valve stem 46 to open the Zone 3 valve 26, and a vent cam 64 is interacting with the valve stem 50 of the vent valve 30 to open the vent valve. The vent is therefore in fluid communication with Zone 3 valve to permit venting of Zone 3. All other zones are closed.

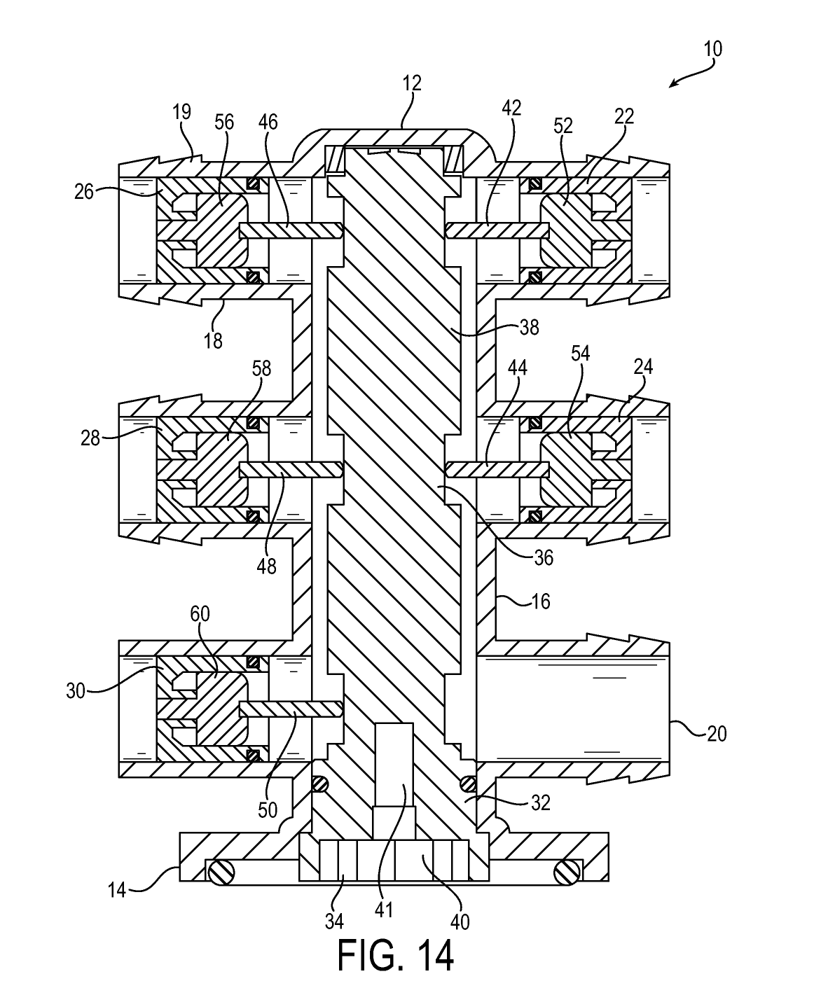

FIG. 14 is a drawing depicting a side cross-sectional view of the exemplary control valve 10, with the cam shaft angle at the 240° position. Referring to the chart of FIG. 7, all zones (including the vent) are closed. As seen in FIG. 14, at such positioning none of the cams of the cam shaft are interacting against the zone or vent valves.

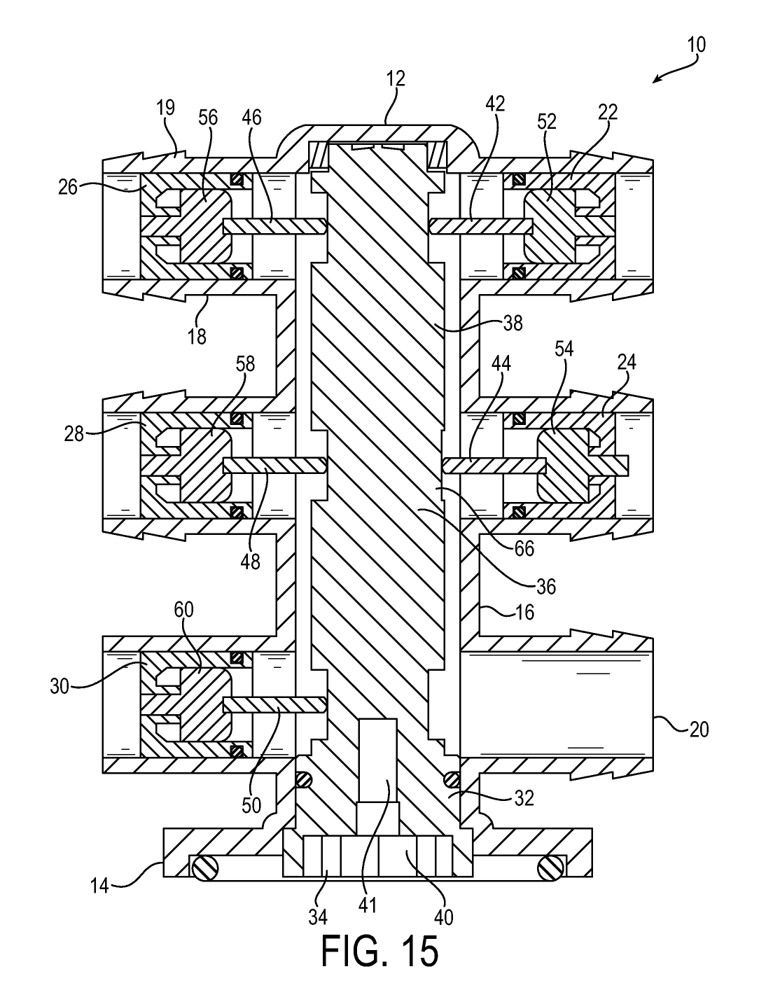

FIG. 15 is a drawing depicting a side cross-sectional view of the exemplary control valve 10, with the cam shaft angle at the 270° position. Referring to the chart of FIG. 7, Zone 2 is being inflated. As seen in FIG. 15, the second cam 66 is interacting against the second valve stem 44 to open the Zone 2 valve 24. All other zones (including the vent) are closed.

And so on through the entire 360° rotation (return to the 0° position) of the cam shaft as set forth in the chart of FIG. 7. In this manner, the control valve 10 is configured as a single, multi-circuit (flow path) valve assembly that can control the pressure through multiple zones and a vent, which provides enhanced control as compared to conventional configurations.

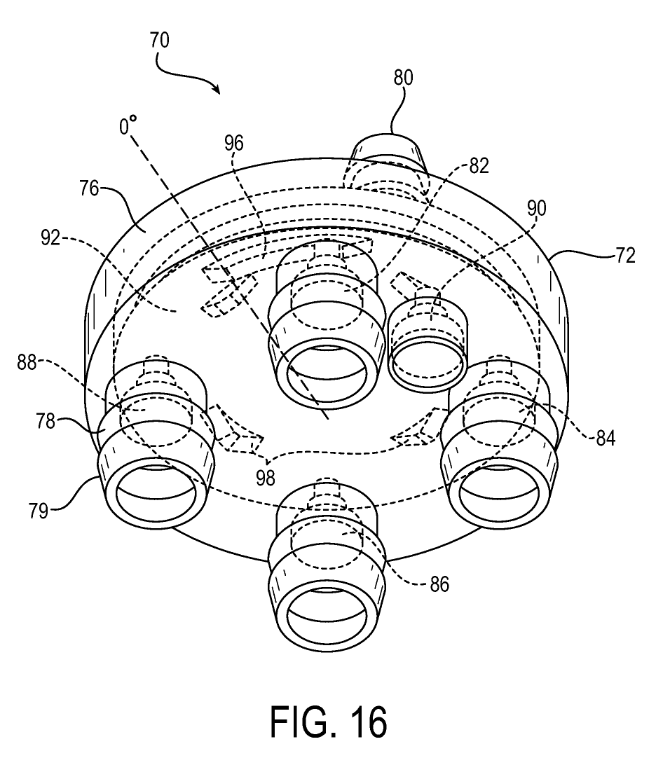

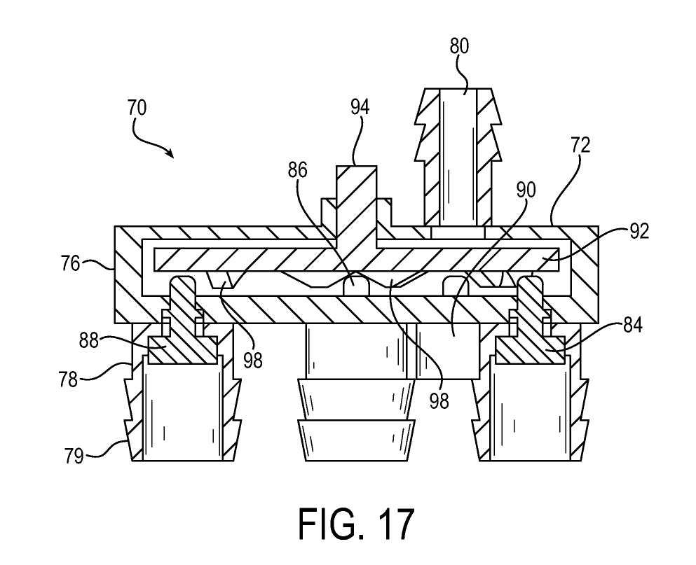

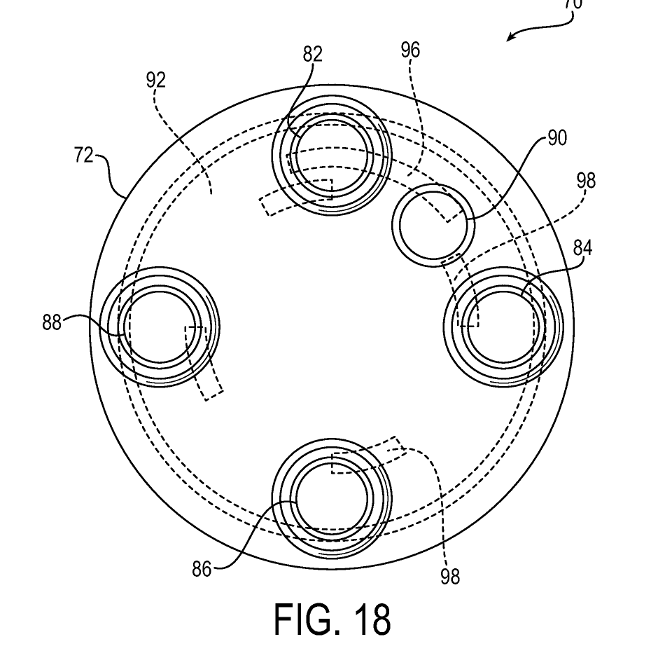

FIG. 16 is a drawing depicting an isometric view of a second exemplary control valve 70 in accordance with embodiments of the present invention. FIG. 17 is a drawing depicting a side cross-sectional view of the second exemplary control valve 70 of FIG. 16. FIG. 18 is a drawing depicting a bottom view of the second exemplary control valve 70 of FIG. 16. The embodiment of FIGS. 16-18 differs from the previous embodiment in that the moveable member is configured as a rotating disc from which the cams extend for interacting with the zone valves and vent valve.

The control valve 70 includes a body 72, and the body 72 in turn includes a cam housing 76, a plurality of individual valve housings 78, and an inlet 80. In such configuration, the cam housing 76 has a widened circular cross section, and the individual valve housings 78 extend from a same side of the cam housing 76, which is an opposite side of the cam housing 76 from the inlet 80. The inlet 80 constitutes an inlet for communicating a pressurized fluid, such as pressurized air or other fluid, from a pump (not shown) into the control valve 70.

Similarly to the previous embodiment, there are at least two zone valves and a vent valve, although the precise number of valves may be varied. In the example of FIGS. 16-18, there are again five individual valves housings 78 that each receives a corresponding valve located within a respective individual valve housing. Four of the valves provide flow paths or a flow “circuit” for the pressurized air to be delivered into a pressure zone of a multiple zoned inflatable object. The example control valve 70 includes four zone valves: Zone 1 valve 82, Zone 2 valve 84, Zone 3 valve 86, and Zone 4 valve 88. In this example configuration, the Zone valves are spaced circumferentially about the circular cross section of the cam housing 76 portion of the body 72. The valve housings 78 for the zone valves, and the inlet 80, may include ridges 79 for coupling to appropriate hose elements for communicating the pressurized air into the zoned inflatable object.

The control valve 70 further includes a fifth Vent valve 90 that provides a vent to atmosphere. In this configuration, the Vent valve extends from the cam housing at a distance smaller than the zone valves. In addition, the Vent valve is spaced slightly radially inward on the valve housing as compared to the Zone valves. It again will be appreciated that the number of zone and/or vent valves may be varied. The example of FIGS. 15-17 also includes a total of six ports (inlet, vent, and four zones), and more or less ports may be provided. To accommodate a larger number of ports, the size of the cam housing 76 and the rotating member (cam disc) may be increased as warranted.

In the example of FIGS. 16-18, as referenced above the cam housing 76 receives a moveable member configured as a rotating cam disc 92, which extends laterally through the cam housing. The cam disc 92 is fixed to a drive shaft 94 (see particularly FIG. 17) that that extends from the body 72 to interface with a motor (not shown). In other words, the motor drives the rotation of the drive shaft 94, which in turn drives rotation of the cam disc 92. There are similarities of operation in this second embodiment as compared to the previous embodiment. In general operation, based on the rotational position of the cam disc, cams that extend from the cam disc open and close the zone and vent valves in a prescribed order to control pressure in the multiple zones of the zoned inflatable object associated with and in fluid communication with the zone valves. At each particular rotational position of the cam disc, the cams may interact to open one or more of the zone valves and vent valve, or all the valves may be closed.

As seen in FIGS. 16-18, with the cam disc configuration, a first cam 96 is associated with the control of Zone valves. In addition, a plurality of Vent cams 98 are associated with the control of the Vent valve. Because the Vent valve is located slightly radially inward relative to the Zone valves, the Vent cams 98 commensurately are located slightly radially inward relative to the first cam 96.

In the specific rotational position of the cam disc 92 in FIG. 16, the first cam 96 is interacting against Zone 1 valve 82 to open the Zone 1 valve. In addition, at the depicted rotational position, a vent cam 98 extends so as to interact against the Vent valve 90, thereby opening the Vent valve 90. In other words, at the depicted rotational position of FIG. 16, both the Zone 1 valve 82 and Vent valve 90 are open. It is further seen that no cams are interacting with any other of the Zone valves for Zones 2, 3, and 4. The depicted rotational position, therefore, is used to vent Zone 1 to regulate the Zone 1 pressure. Air can flow through the Zone 1 valve 82 and be vented out through the Vent valve 90. Generally, comparably to the previous embodiment, at any given rotational position of the cam disc, the cam extensions are positioned to one of: opening one of the zone valves, opening one of the zone valves and the vent valve, or maintaining all of the plurality of valves closed.

Similarly to the previous embodiment, the 0° angle or rotational position of the cam disc 92 is defined as the position at which Zone 1 is inflated. Assuming that the cam disc 92 rotates counterclockwise (similarly as the cam shaft 32 in the first embodiment), the Zone 1 valve 82 will make first contact with the first cam 96 at the 0° position, the 0° being indicated with the dashed line in FIG. 16. At such 0° position, there is no interaction of any of the vent cams 98 with the Vent valve 90. The cam disc then may be rotated 30° to the actual position depicted in FIG. 16. Similarly to the first and second cams of the previous embodiment, the first cam 96 of the second embodiment also has an arc expanse of 30°. In other words, as the cam disc 92 rotates from the 0° rotational position to the 30° rotational position of FIG. 16, the first cam 96 will retain the Zone 1 valve 82 in the open position over the rotation of 30° of the cam disc. Again similarly to the previous embodiment, the Vent cams 98 lack such arc expanse, and so the Vent cam will release the Vent valve, thereby closing the Vent valve, upon small rotation from the interacting position.

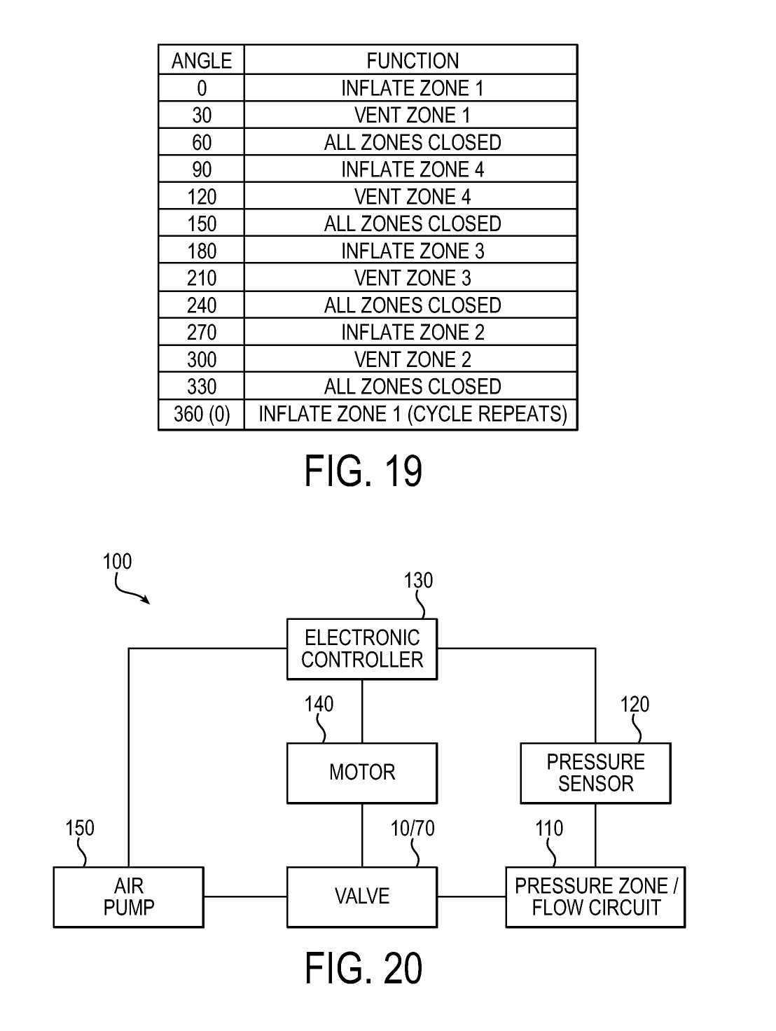

In this manner, based on the rotational position of the cam disc 92, cams 96 and 98 that extend from the cam disc s open and close the zone and vent valves in a prescribed order to control pressure in the multiple zones of a zoned inflatable object associated with and in fluid communication with the zone valves. At each particular rotational position of cam disc, the cams may interact to open one or more of the zone valves and vent valve, or all the valves may be closed. FIG. 19 is a chart depicting rotational positions as related to control valve function for the control valve 70 of FIG. 16. As referenced above, FIG. 16 corresponds to the 30° position in the chart of FIG. 19. The chart of FIG. 19, therefore, follows a progression with counterclockwise rotation of the cam disc 92, similarly as the progression shown in the chart of FIG. 7 with counterclockwise rotation of the cam shaft 32. Because of the cam disc shape of the second embodiment relative to the cylindrical cam shaft of the first embodiment, the precise progression of the valve interactions differs in certain respects. However, both embodiments operate in accordance with the common general principle, that interactions with cams on a rotating member open and close the zone and vent valves in a prescribed order to control pressure in the multiple zones associated with the zone valves.

The control valves as described above may be employed in a control system for controlling pressure in multiple zones of a zoned object having multiple pressure zones in a flow circuit. FIG. 20 is a drawing depicting a block diagram of operative portions of an exemplary control system 100 for controlling pressure and/or flow in a zoned object using the described control valve 10 (or 70). The zoned object is represented by block 110, and, for example, may be an air mattress or any other suitable device that is divided into multiple pressure zones or pressure circuits for inflation with a pressurized fluid, such as pressurized air. Pressures sensors 120 as are known in the art may sense pressure in each of the multiple zones of pressure zone/flow circuit 110, and the pressure information from the pressure sensors 120 is inputted into an electronic controller 130. The electronic controller 130 may be any suitable control device, such as a microprocessor, CPU, microcomputer or like devices as are known in the art. The electronic controller further may include any suitable computer readable media, such as computer memory devices, that store program code that is executed by a processor device to carry out the functions of the electronic controller 130. The electronic controller is configured to receive pressure information from the pressure sensor and to control a pump and a motor based on the pressure information, wherein the electronic controller controls the motor to drive the rotating member of the control valve to a rotational position from among a plurality of rotational positions based on the sensor information.

In exemplary embodiments, based on the pressure information gathered by the pressure sensors 120, the electronic controller 130 may control a motor 140 to drive the control valve 10 (or 70) to the appropriate rotational position from the available rotation positions. Such rotational positions may correspond to those depicted in the chart of FIG. 7 for control valve 10, or the chart of FIG. 19 for control valve 70. In exemplary embodiments, the motor 140 may be a low torque electric motor, although any suitable motor may be employed. The electronic controller also may control a pump 150 (e.g., air pump) to provide a supply of pressurized air or other suitable fluid as needed. For example, looking at the chart of FIG. 7, suppose the pressure sensors 120 indicate a deficient pressure condition in Zone 3 of the pressure zone/flow circuit 110. The electronic controller 130 will control the motor 140 to drive the cam shaft 32 to the 180° position to open the Zone 3 valve for inflation of Zone 3. The electronic controller 130 further may control the pump 150 to supply pressurized air into the control valve 10, which by virtue of the valve positioning will flow so as to inflate Zone 3 of the pressure zone/flow circuit 110.

At some point, there may be a pressure overshoot in which the pressure in Zone 3 exceeds the desired pressure, as sensed by the pressure sensors 120. At such point, referring again to the chart of FIG. 7, the electronic controller 130 will control the motor 140 to drive the cam shaft 32 to reposition the cam shaft to the 210° position to retain the Zone 3 valve open while also opening the Vent valve. The electronic controller 130 further may control the pump 150 to shut off the supply of pressurized air to the control valve 10. By virtue of the valve positioning, excess pressure in Zone 3 will cause air to flow back through the Zone 3 valve and out the Vent valve to vent the excess pressure from Zone 3. Once a stable desired pressure is achieved, the electronic controller 130 may control the motor 140 to drive the cam shaft 32 to the 240° position to close all the Zone valves and the vent valve. Pressure control may be achieved for any of Zones 1-4 in like manner, and similar control may be applied to the control valve 70 of the second embodiment.

An aspect of the invention, therefore, is a control valve. In exemplary embodiments, the control valve includes a valve housing, a plurality of valves located within the valve housing, and a moveable member that is configured to move within the housing, the moveable member including a plurality of cam extensions. As the moveable member moves within the housing, the cam extensions interact against the plurality of valves to open and close the plurality of valves in a prescribed order.

In an exemplary embodiment, the prescribed order may be a sequential order.

In an exemplary embodiment of the control valve, the plurality of valves includes at least two zone valves, wherein the at least two zone valves each comprises a fluid pathway for communicating a pressurized fluid when in an open position.

In an exemplary embodiment of the control valve, the control valve further includes a vent valve that is in fluid communication with at least one zone valve when the vent valve is in an open position.

In an exemplary embodiment of the control valve, the moveable member is a rotating member, and at any given rotational position of the rotating member, the cam extensions are positioned to one of: opening one of the zone valves, opening one of the zone valves and the vent valve, or maintaining all of the plurality of valves closed.

In an exemplary embodiment of the control valve, the moveable member comprises a cylindrical cam shaft, and the plurality of cam extensions extend radially from the cam shaft.

In an exemplary embodiment of the control valve, the cam extensions comprise at least a first cam for interacting against the zone valves and a vent cam for interacting against the vent valve as the rotating member rotates.

In an exemplary embodiment of the control valve, the first cam has an arc expanse for maintaining one of the zone valves in an open position as the rotating member rotates over the arc expanse.

In an exemplary embodiment of the control valve, the arc expanse of the first cam is 30°.

In an exemplary embodiment of the control valve, the control valve further includes an inlet configured to receive a pressurized fluid.

In an exemplary embodiment of the control valve, the moveable member comprises a cylindrical cam shaft, and the plurality of cam extensions extend radially from the cam shaft, the valve housing comprises a cylindrical cam housing in which the cam shaft rotates, and a plurality of individual valve housings that respectively house the plurality of valves, and at least some of the individual valve housings extend from opposite sides of the cam housing.

In an exemplary embodiment of the control valve, the plurality of valves comprises at least two zone valves and a vent valve, the at least two zone valves each comprises a fluid pathway for communicating a pressurized fluid when in an open position, and the vent valve is in fluid communication with the zone valves when the vent valve is in an open position, and the zone valves are positioned opposite to each other relative to the cam housing.

In an exemplary embodiment of the control valve, the at least two zone valves comprises four zone valves, and the four zone valves are positioned in two pairs of zone valves in which the two zone valves of a pair are positioned opposite to each other relative to the cam housing.

In an exemplary embodiment of the control valve, the control valve further includes an inlet configured to receive a pressurized fluid, and the inlet is positioned opposite to the vent valve relative to the cam housing.

In an exemplary embodiment of the control valve, at any given rotational position of the cam shaft, the cam extensions are positioned to one of: opening one of the zone valves, opening one of the zone valves and the vent valve, or maintaining all of the plurality of valves closed.

In an exemplary embodiment of the control valve, the moveable member comprises a cam disc, and the cam extensions extend outward from the cam disc, the valve housing comprises a cam housing in which the cam disc rotates, and a plurality of individual valve housings that respectively house the plurality of valves; and the individual valve housings extend from a same side of the cam housing.

In an exemplary embodiment of the control valve, the plurality of valves comprises at least two zone valves and a vent valve; the at least two zone valves each comprises a fluid pathway for communicating a pressurized fluid when in an open position, and the vent valve is in fluid communication with the at least one zone valve when the vent valve is in an open position; and the zone valves and the vent valve are spaced circumferentially around the cam housing, with the vent valve being positioned radially inward relative to zone valves.

In an exemplary embodiment of the control valve, the cam extensions comprise a first cam for interacting against the zone valves and a vent cam for interacting against the vent valve as the cam disc rotates.

In an exemplary embodiment of the control valve, at any given rotational position of the cam disc, the cam extensions are positioned to one of: opening one of the zone valves, opening one of the zone valves and the vent valve, or maintaining all of the plurality of valves closed.

Another aspect of the invention is a control system for controlling pressure or flow in a zoned object. In exemplary embodiments, the control system includes a zoned object having multiple zones to be subjected to a pressurized fluid; the control valve in fluid communication with the zoned object; a motor configured to drive the moveable member of the control valve; a pump for pumping the pressurized fluid for inflating the zoned object; a pressure sensor for sensing a pressure in each of the multiple zones of the zoned object; and an electronic controller configured to receive pressure information from the pressure sensor and to control the pump and motor based on the pressure information, wherein the electronic controller controls the motor to drive the moveable member to a position from among a plurality of positions based on the sensor information.

In an exemplary embodiment of the control system, the zoned object is an air mattress.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A control valve comprising:
a valve housing;
a plurality of valves located within the valve housing, and
a moveable member that is configured to move within the housing, the moveable member including a plurality of cam extensions;
wherein as the moveable member moves within the housing, the cam extensions interact against the plurality of valves to open and close the plurality of valves in a prescribed order.

2. The control valve of claim 1, wherein the plurality of valves comprises at least two zone valves, wherein the at least two zone valves each comprises a fluid pathway for communicating a pressurized fluid when in an open position.

3. The control valve of claim 2, further comprising a vent valve that is in fluid communication with at least one zone valve when the vent valve is in an open position.

4. The control valve of claim 3, wherein the moveable member is a rotating member, and at any given rotational position of the rotating member, the cam extensions are positioned to one of: opening one of the zone valves, opening one of the zone valves and the vent valve, or maintaining all of the plurality of valves closed.

5. The control valve of claim 1, wherein the moveable member comprises a cylindrical cam shaft, and the plurality of cam extensions extend radially from the cam shaft.

6. The control valve of claim 2, wherein the cam extensions comprise at least a first cam for interacting against the zone valves and a vent cam for interacting against the vent valve as the rotating member rotates.

7. The control valve of claim 6, wherein the first cam has an arc expanse for maintaining one of the zone valves in an open position as the rotating member rotates over the arc expanse.

8. The control valve of claim 7, wherein the arc expanse of the first cam is 30°.

9. The control valve of claim 1, further comprising an inlet configured to receive a pressurized fluid.

10. The control valve of claim 1, wherein:
the moveable member comprises a cylindrical cam shaft, and the plurality of cam extensions extend radially from the cam shaft;
the valve housing comprises a cylindrical cam housing in which the cam shaft rotates, and a plurality of individual valve housings that respectively house the plurality of valves; and
at least some of the individual valve housings extend from opposite sides of the cam housing.

11. The control valve of claim 10, wherein:
the plurality of valves comprises at least two zone valves and a vent valve;
the at least two zone valves each comprises a fluid pathway for communicating a pressurized fluid when in an open position, and the vent valve is in fluid communication with the zone valves when the vent valve is in an open position; and
the zone valves are positioned opposite to each other relative to the cam housing.

12. The control valve of claim 11, wherein the at least two zone valves comprises four zone valves, and the four zone valves are positioned in two pairs of zone valves in which the two zone valves of a pair are positioned opposite to each other relative to the cam housing.

13. The control valve of claim 12, further comprising an inlet configured to receive a pressurized fluid, and the inlet is positioned opposite to the vent valve relative to the cam housing.

14. The control valve of claim 11, wherein at any given rotational position of the cam shaft, the cam extensions are positioned to one of: opening one of the zone valves, opening one of the zone valves and the vent valve, or maintaining all of the plurality of valves closed.

15. The control valve of claim 1, wherein:
the moveable member comprises a cam disc, and the cam extensions extend outward from the cam disc;
the valve housing comprises a cam housing in which the cam disc rotates, and a plurality of individual valve housings that respectively house the plurality of valves; and
the individual valve housings extend from a same side of the cam housing.

16. The control valve of claim 15, wherein:
the plurality of valves comprises at least two zone valves and a vent valve;
the at least two zone valves each comprises a fluid pathway for communicating a pressurized fluid when in an open position, and the vent valve is in fluid communication with the at least one zone valve when the vent valve is in an open position; and
the zone valves and the vent valve are spaced circumferentially around the cam housing, with the vent valve being positioned radially inward relative to zone valves.

17. The control valve of claim 16, wherein the cam extensions comprise a first cam for interacting against the zone valves and a vent cam for interacting against the vent valve as the cam disc rotates.

18. The control valve of claim 15, wherein at any given rotational position of the cam disc, the cam extensions are positioned to one of: opening one of the zone valves, opening one of the zone valves and the vent valve, or maintaining all of the plurality of valves closed.

19. A control system for controlling pressure or flow in a zoned object comprising:
a zoned object having multiple zones to be subjected to a pressurized fluid;
a control valve of claim 1 in fluid communication with the zoned object;
a motor configured to drive the moveable member of the control valve;
a pump for pumping the pressurized fluid for inflating the zoned object;
a pressure sensor for sensing a pressure in each of the multiple zones of the zoned object; and
an electronic controller configured to receive pressure information from the pressure sensor and to control the pump and motor based on the pressure information, wherein the electronic controller controls the motor to drive the moveable member to a position from among a plurality of positions based on the sensor information.

20. The control system of claim 19, wherein the zoned object is an air mattress.
